(19) United States
(12) Patent Application Publication
(10) Pub. No.: US 2016/0048529 A1
(43) Pub. Date: Feb. 18, 2016

(54) COALESCING STORAGE OPERATIONS

(71) Applicant: NetApp Inc., Sunnyvale, CA (US)

(72) Inventors: Ankit Mathur, Bangalore (IN); Sudip Kumar Panda, Bangalore (IN); Sandeep Joshi, Bangalore (IN)

(21) Appl. No.: 14/458,448

(22) Filed: Aug. 13, 2014

(51) Int. Cl. G06F 17/30

(52) U.S. Cl. CPC G06F 17/30117; G06F 17/30088

(57) ABSTRACT

One or more techniques and/or systems are provided for coalescing storage operations. For example, a storage operation may be received from a client by a file server configured to provide access to data stored within one or more storage devices. A notification of the storage operation may be created for tracking purposes. A coalescing policy may be enforced such that additional notifications are not created for subsequent storage operations until the coalescing policy is unenforced (e.g., after a predefined period of time lapses). Enforcement of the coalescing policy, for example, mitigates tracking an excess number of storage operations that may otherwise utilize processing resources, consume bandwidth, provide redundant information that may be of little to no value, etc.

### BACKGROUND

A file server (e.g., server, storage server, data storage and management server, etc.) may provide clients with access to files stored on one or more storage devices. Policy services that implement storage policies, auditing services that track user access to file, and/or other services may track storage operations performed by the file server on behalf of the clients. Because a relatively large number of storage operations may be tracked, increased latency, processing resource consumption, bandwidth consumption, noise from inessential tracking information (e.g., an auditing service may seek information regarding merely whether a user opens a file, and thus each write operation performed while the file is open may be noise for the auditing service), and/or other issues may result.

### DESCRIPTION OF THE DRAWINGS

FIG. 1 is a component block diagram illustrating an example clustered network in accordance with one or more of the provisions set forth herein.

FIG. 2 is a component block diagram illustrating an example data storage system in accordance with one or more of the provisions set forth herein.

FIG. 3 is a flow chart illustrating an exemplary method of coalescing storage operations.

FIG. 4 is a component block diagram illustrating an exemplary system for coalescing storage operations based upon an expiration time.

FIG. 5 is a component block diagram illustrating an exemplary system for coalescing storage operations based upon an expiration time.

FIG. 6 is a component block diagram illustrating an exemplary system for coalescing storage operations based upon a threshold number of subsequent storage operations.

FIG. 7 is a component block diagram illustrating an exemplary system for coalescing storage operations based upon a receiving event.

FIG. 8 is an example of a computer readable medium in accordance with one or more of the provisions set forth herein.

### DETAILED DESCRIPTION

Some examples of the claimed subject matter are now described with reference to the drawings, where like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. Nothing in this detailed description is admitted as prior art.

One or more systems and/or techniques for coalescing storage operations are provided. When a first storage operation from a client device is received (e.g., a client attempts to open a text document through a file server), a first record of the storage operation may be created. An expiration event may be defined for the first record (e.g., the first record may be retained for 3 minutes; retained until a threshold number of subsequent storage operations are received; retained until a service requests access to record information; etc.). A first notification of the first storage operation may be created based upon the first record. The first notification may be sent to a service (e.g., an auditing service may express an interest in receiving notifications of storage operations that access text documents). A coalescing policy may be enforced until expiration of the expiration event. The coalescing policy may block the triggering of creating new notifications for subsequent storage operations (e.g., a plethora of subsequent write operations to the text document may be received from the client device based upon edits made to the text document by a user; a read operation of a 50 mb text document may comprise a substantial number of incremental 64 kb read operations; etc., but the creation of new notifications may not be triggered by such storage operations due to the existence of the coalescing policy). Responsive to expiration of the expiration event, the first record may be deleted and the coalescing policy may be unenforced (e.g., a subsequent storage operation for the text document from the client device may trigger creation of a new record and a new notification). Coalescing storage operations may reduce the number of notifications sent to the service, which may reduce network bandwidth utilization, noise (e.g., the auditing service may merely have an interest in knowing that the user accessed the text document, but may be uninterested in additional notifications about edits to the text document), latency, and/or processing resource utilization.

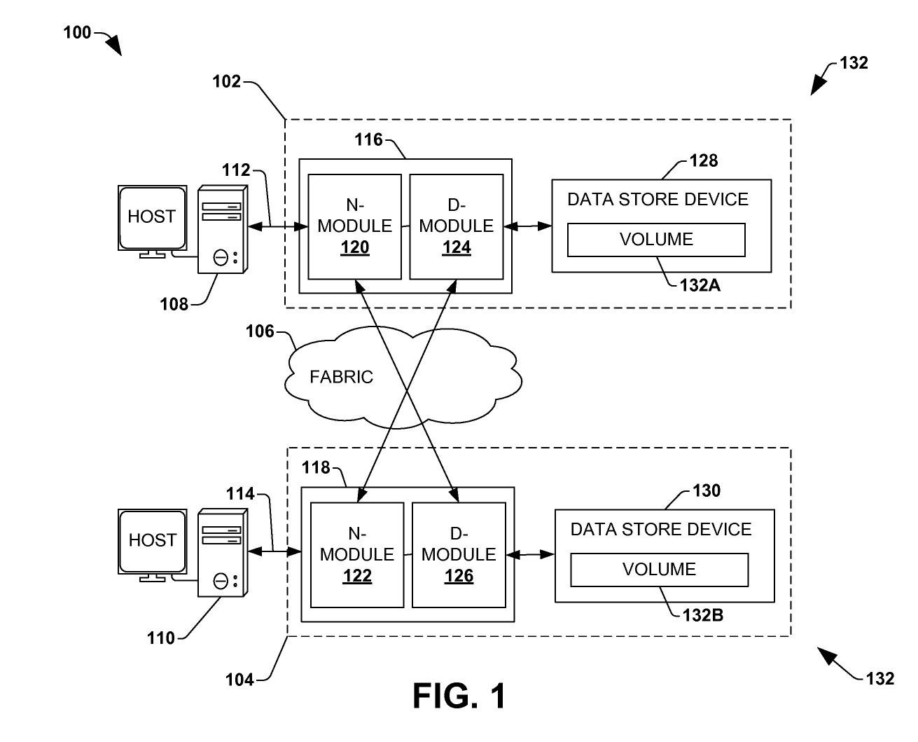

To provide context for coalescing storage operations, FIG. 1 illustrates an embodiment of a clustered network environment or a network storage environment 100. It may be appreciated, however, that the techniques, etc. described herein may be implemented within the clustered network environment 100, a non-cluster network environment, and/or a variety of other computing environments, such as a desktop computing environment. That is, the instant disclosure, including the scope of the appended claims, is not meant to be limited to the examples provided herein. It will be appreciated that where the same or similar components, elements, features, items, modules, etc. are illustrated in later figures but were previously discussed with regard to prior figures, that a similar (e.g., redundant) discussion of the same may be omitted when describing the subsequent figures (e.g., for purposes of simplicity and ease of understanding).

FIG. 1 is a block diagram illustrating an example clustered network environment 100 that may implement at least some embodiments of the techniques and/or systems described herein. The example environment 100 comprises data storage systems or storage sites 102 and 104 that are coupled over a cluster fabric 106, such as a computing network embodied as a private Infiniband or Fibre Channel (FC) network facilitating communication between the storage systems 102 and 104 (and one or more modules, component, etc. therein, such as, nodes 116 and 118, for example). It will be appreciated that while two data storage systems 102 and 104 and two nodes 116 and 118 are illustrated in FIG. 1, that any suitable number of such components is contemplated. In an example, nodes 116, 118 comprise storage controllers (e.g., node 116 may comprise a primary or local storage controller and node 118 may comprise a secondary or remote storage controller) that provide client devices, such as host devices 108, 110, with access to data stored within data storage devices 128, 130. Similarly, unless specifically provided otherwise herein, the same is true for other modules, elements, features, items, etc. referenced herein and/or illustrated in the accompanying drawings. That is, a particular number of components, modules, elements, features, items, etc. disclosed herein is not meant to be interpreted in a limiting manner.

It will be further appreciated that clustered networks are not limited to any particular geographic areas and can be clustered locally and/or remotely. Thus, in one embodiment a clustered network can be distributed over a plurality of storage systems and/or nodes located in a plurality of geographic locations; while in another embodiment a clustered network can include data storage systems (e.g., 102, 104) residing in a same geographic location (e.g., in a single onsite rack of data storage devices).

In the illustrated example, one or more host devices 108, 110 which may comprise, for example, client devices, personal computers (PCs), computing devices used for storage (e.g., storage servers), and other computers or peripheral devices (e.g., printers), are coupled to the respective data storage systems 102, 104 by storage network connections 112, 114. Network connection may comprise a local area network (LAN) or wide area network (WAN), for example, that utilizes Network Attached Storage (NAS) protocols, such as a Common Internet File System (CIFS) protocol or a Network File System (NFS) protocol to exchange data packets. Illustratively, the host devices 108, 110 may be general-purpose computers running applications, and may interact with the data storage systems 102, 104 using a client/server model for exchange of information. That is, the host device may request data from the data storage system (e.g., data on a storage device managed by a network storage control configured to process I/O commands issued by the host device for the storage device), and the data storage system may return results of the request to the host device via one or more network connections 112, 114.

The nodes 116, 118 on clustered data storage systems 102, 104 can comprise network or host nodes that are interconnected as a cluster to provide data storage and management services, such as to an enterprise having remote locations, for example. Such a node in a data storage and management network cluster environment 100 can be a device attached to the network as a connection point, redistribution point or communication endpoint, for example. A node may be capable of sending, receiving, and/or forwarding information over a network communications channel, and could comprise any device that meets any or all of these criteria. One example of a node may be a data storage and management server attached to a network, where the server can comprise a general purpose computer or a computing device particularly configured to operate as a server in a data storage and management system.

In an example, a first cluster of nodes such as the nodes 116, 118 (e.g., a first set of storage controllers configured to provide access to a first storage aggregate comprising a first logical grouping of one or more storage devices) may be located on a first storage site. A second cluster of nodes, not illustrated, may be located at a second storage site (e.g., a second set of storage controllers configured to provide access to a second storage aggregate comprising a second logical grouping of one or more storage devices). The first cluster of nodes and the second cluster of nodes may be configured according to a disaster recovery configuration where a surviving cluster of nodes provides switchover access to storage devices of a disaster cluster of nodes in the event a disaster occurs at a disaster storage site comprising the disaster cluster of nodes (e.g., the first cluster of nodes provides client devices with switchover data access to storage devices of the second storage aggregate in the event a disaster occurs at the second storage site).

As illustrated in the exemplary environment 100, nodes 116, 118 can comprise various functional components that coordinate to provide distributed storage architecture for the cluster. For example, the nodes can comprise a network module 120, 122 (e.g., N-Module, or N-Blade) and a data module 124, 126 (e.g., D-Module, or D-Blade). Network modules 120, 122 can be configured to allow the nodes 116, 118 (e.g., network storage controllers) to connect with host devices 108, 110 over the network connections 112, 114, for example, allowing the host devices 108, 110 to access data stored in the distributed storage system. Further, the network modules 120, 122 can provide connections with one or more other components through the cluster fabric 106. For example, in FIG. 1, a first network module 120 of first node 116 can access a second data storage device 130 by sending a request through a second data module 126 of a second node 118.

Data modules 124, 126 can be configured to connect one or more data storage devices 128, 130, such as disks or arrays of disks, flash memory, or some other form of data storage, to the nodes 116, 118. The nodes 116, 118 can be interconnected by the cluster fabric 106, for example, allowing respective nodes in the cluster to access data on data storage devices 128, 130 connected to different nodes in the cluster. Often, data modules 124, 126 communicate with the data storage devices 128, 130 according to a storage area network (SAN) protocol, such as Small Computer System Interface (SCSI) or Fiber Channel Protocol (FCP), for example. Thus, as seen from an operating system on a node 116, 118, the data storage devices 128, 130 can appear as locally attached to the operating system. In this manner, different nodes 116, 118, etc. may access data blocks through the operating system, rather than expressly requesting abstract files.

It should be appreciated that, while the example embodiment 100 illustrates an equal number of N and D modules, other embodiments may comprise a differing number of these modules. For example, there may be a plurality of N and/or D modules interconnected in a cluster that does not have a one-to-one correspondence between the N and D modules. That is, different nodes can have a different number of N and D modules, and the same node can have a different number of N modules than D modules.

Further, a host device 108, 110 can be networked with the nodes 116, 118 in the cluster, over the networking connections 112, 114. As an example, respective host devices 108, 110 that are networked to a cluster may request services (e.g., exchanging of information in the form of data packets) of a node 116, 118 in the cluster, and the node 116, 118 can return results of the requested services to the host devices 108, 110. In one embodiment, the host devices 108, 110 can exchange information with the network modules 120, 122 residing in the nodes (e.g., network hosts) 116, 118 in the data storage systems 102, 104.

In one embodiment, the data storage devices 128, 130 comprise volumes 132, which is an implementation of storage of information onto disk drives or disk arrays or other storage (e.g., flash) as a file-system for data, for example. Volumes can span a portion of a disk, a collection of disks, or portions of disks, for example, and typically define an overall logical arrangement of file storage on disk space in the storage system. In one embodiment a volume can comprise stored data as one or more files that reside in a hierarchical directory structure within the volume.

Volumes are typically configured in formats that may be associated with particular storage systems, and respective volume formats typically comprise features that provide functionality to the volumes, such as providing an ability for volumes to form clusters. For example, where a first storage system may utilize a first format for their volumes, a second storage system may utilize a second format for their volumes.

In the example environment 100, the host devices 108, 110 can utilize the data storage systems 102, 104 to store and retrieve data from the volumes 132. In this embodiment, for example, the host device 108 can send data packets to the N-module 120 in the node 116 within data storage system 102. The node 116 can forward the data to the data storage device 128 using the D-module 124, where the data storage device 128 comprises volume 132A. In this way, in this example, the host device can access the storage volume 132A, to store and/or retrieve data, using the data storage system 102 connected by the network connection 112. Further, in this embodiment, the host device 110 can exchange data with the N-module 122 in the host 118 within the data storage system 104 (e.g., which may be remote from the data storage system 102). The host 118 can forward the data to the data storage device 130 using the D-module 126, thereby accessing volume 132B associated with the data storage device 130.

It may be appreciated that coalescing storage operations may be implemented within the clustered network environment 100. For example, a coalescing component may be implemented for the node 116 and/or the node 118. The coalescing component may be configured to coalesce storage operations received by the node 116 and/or the node 118 from the host device 108 and/or the host device 110.

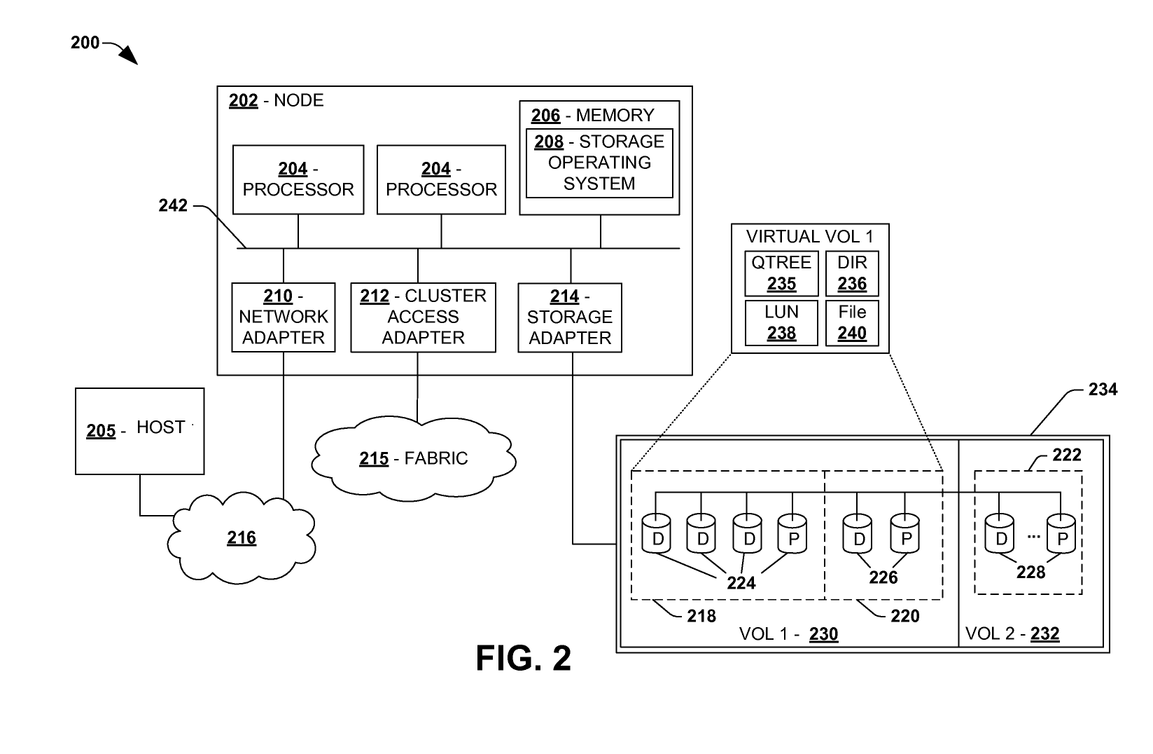

FIG. 2 is an illustrative example of a data storage system 200 (e.g., 102, 104 in FIG. 1), providing further detail of an embodiment of components that may implement one or more of the techniques and/or systems described herein. The example data storage system 200 comprises a node 202 (e.g., host nodes 116, 118 in FIG. 1), and a data storage device 234 (e.g., data storage devices 128, 130 in FIG. 1). The node 202 may be a general purpose computer, for example, or some other computing device particularly configured to operate as a storage server. A host device 205 (e.g., 108, 110 in FIG. 1) can be connected to the node 202 over a network 216, for example, to provides access to files and/or other data stored on the data storage device 234. In an example, the node 202 comprises a storage controller that provides client devices, such as the host device 205, with access to data stored within data storage device 234.

The data storage device 234 can comprise mass storage devices, such as disks 224, 226, 228 of a disk array 218, 220, 222. It will be appreciated that the techniques and systems, described herein, are not limited by the example embodiment. For example, disks 224, 226, 228 may comprise any type of mass storage devices, including but not limited to magnetic disk drives, flash memory, and any other similar media adapted to store information, including, for example, data (D) and/or parity (P) information.

The node 202 comprises one or more processors 204, a memory 206, a network adapter 210, a cluster access adapter 212, and a storage adapter 214 interconnected by a system bus 242. The storage system 200 also includes an operating system 208 installed in the memory 206 of the node 202 that can, for example, implement a Redundant Array of Independent (or Inexpensive) Disks (RAID) optimization technique to optimize a reconstruction process of data of a failed disk in an array.

The operating system 208 can also manage communications for the data storage system, and communications between other data storage systems that may be in a clustered network, such as attached to a cluster fabric 215 (e.g., 106 in FIG. 1). Thus, the node 202, such as a network storage controller, can respond to host device requests to manage data on the data storage device 234 (e.g., or additional clustered devices) in accordance with these host device requests. The operating system 208 can often establish one or more file systems on the data storage system 200, where a file system can include software code and data structures that implement a persistent hierarchical namespace of files and directories, for example. As an example, when a new data storage device (not shown) is added to a clustered network system, the operating system 208 is informed where, in an existing directory tree, new files associated with the new data storage device are to be stored. This is often referred to as “mounting” a file system.

In the example data storage system 200, memory 206 can include storage locations that are addressable by the processors 204 and adapters 210, 212, 214 for storing related software program code and data structures. The processors 204 and adapters 210, 212, 214 may, for example, include processing elements and/or logic circuitry configured to execute the software code and manipulate the data structures. The operating system 208, portions of which are typically resident in the memory 206 and executed by the processing elements, functionally organizes the storage system by, among other things, invoking storage operations in support of a file service implemented by the storage system. It will be apparent to those skilled in the art that other processing and memory mechanisms, including various computer readable media, may be used for storing and/or executing program instructions pertaining to the techniques described herein. For example, the operating system can also utilize one or more control files (not shown) to aid in the provisioning of virtual machines.

The network adapter 210 includes the mechanical, electrical and signaling circuitry needed to connect the data storage system 200 to a host device 205 over a computer network 216, which may comprise, among other things, a point-to-point connection or a shared medium, such as a local area network. The host device 205 (e.g., 108, 110 of FIG. 1) may be a general-purpose computer configured to execute applications. As described above, the host device 205 may interact with the data storage system 200 in accordance with a client/host model of information delivery.

The storage adapter 214 cooperates with the operating system 208 executing on the node 202 to access information requested by the host device 205 (e.g., access data on a storage device managed by a network storage controller). The information may be stored on any type of attached array of writeable media such as magnetic disk drives, flash memory, and/or any other similar media adapted to store information. In the example data storage system 200, the information can be stored in data blocks on the disks 224, 226, 228. The storage adapter 214 can include input/output (I/O) interface circuitry that couples to the disks over an I/O interconnect arrangement, such as a storage area network (SAN) protocol (e.g., Small Computer System Interface (SCSI), iSCSI, hyperSCSI, Fiber Channel Protocol (FCP)). The information is retrieved by the storage adapter 214 and, if necessary, processed by the one or more processors 204 (or the storage adapter 214 itself) prior to being forwarded over the system bus 242 to the network adapter 210 (and/or the cluster access adapter 212 if sending to another node in the cluster) where the information is formatted into a data packet and returned to the host device 205 over the network connection 216 (and/or returned to another node attached to the cluster over the cluster fabric 215).

In one embodiment, storage of information on arrays 218, 220, 222 can be implemented as one or more storage “volumes” 230, 232 that are comprised of a cluster of disks 224, 226, 228 defining an overall logical arrangement of disk space. The disks 224, 226, 228 that comprise one or more volumes are typically organized as one or more groups of RAIDs. As an example, volume 230 comprises an aggregate of disk arrays 218 and 220, which comprise the cluster of disks 224 and 226.

In one embodiment, to facilitate access to disks 224, 226, 228, the operating system 208 may implement a file system (e.g., write anywhere file system) that logically organizes the information as a hierarchical structure of directories and files on the disks. In this embodiment, respective files may be implemented as a set of disk blocks configured to store information, whereas directories may be implemented as specially formatted files in which information about other files and directories are stored.

Whatever the underlying physical configuration within this data storage system 200, data can be stored as files within physical and/or virtual volumes, which can be associated with respective volume identifiers, such as file system identifiers (FSIDs), which can be 32-bits in length in one example.

A physical volume corresponds to at least a portion of physical storage devices whose address, addressable space, location, etc. doesn't change, such as at least some of one or more data storage devices 234 (e.g., a Redundant Array of Independent (or Inexpensive) Disks (RAID system)). Typically the location of the physical volume doesn't change in that the (range of) address(es) used to access it generally remains constant.

A virtual volume, in contrast, is stored over an aggregate of disparate portions of different physical storage devices. The virtual volume may be a collection of different available portions of different physical storage device locations, such as some available space from each of the disks 224, 226, and/or 228. It will be appreciated that since a virtual volume is not “tied” to any one particular storage device, a virtual volume can be said to include a layer of abstraction or virtualization, which allows it to be resized and/or flexible in some regards.

Further, a virtual volume can include one or more logical unit numbers (LUNs) 238, directories 236, qtrees 235, and files 240. Among other things, these features, but more particularly LUNS, allow the disparate memory locations within which data is stored to be identified, for example, and grouped as data storage unit. As such, the LUNs 238 may be characterized as constituting a virtual disk or drive upon which data within the virtual volume is stored within the aggregate. For example, LUNs are often referred to as virtual drives, such that they emulate a hard drive from a general purpose computer, while they actually comprise data blocks stored in various parts of a volume.

In one embodiment, one or more data storage devices 234 can have one or more physical ports, wherein each physical port can be assigned a target address (e.g., SCSI target address). To represent respective volumes stored on a data storage device, a target address on the data storage device can be used to identify one or more LUNs 238. Thus, for example, when the node 202 connects to a volume 230, 232 through the storage adapter 214, a connection between the node 202 and the one or more LUNs 238 underlying the volume is created.

In one embodiment, respective target addresses can identify multiple LUNs, such that a target address can represent multiple volumes. The I/O interface, which can be implemented as circuitry and/or software in the storage adapter 214 or as executable code residing in memory 206 and executed by the processors 204, for example, can connect to volume 230 by using one or more addresses that identify the LUNs 238.

It may be appreciated that coalescing storage operations may be implemented for the data storage system 200. For example, a coalescing component may be implemented for the node 202. The coalescing component may be configured to coalesce storage operations received by the node 202 from the host 205.

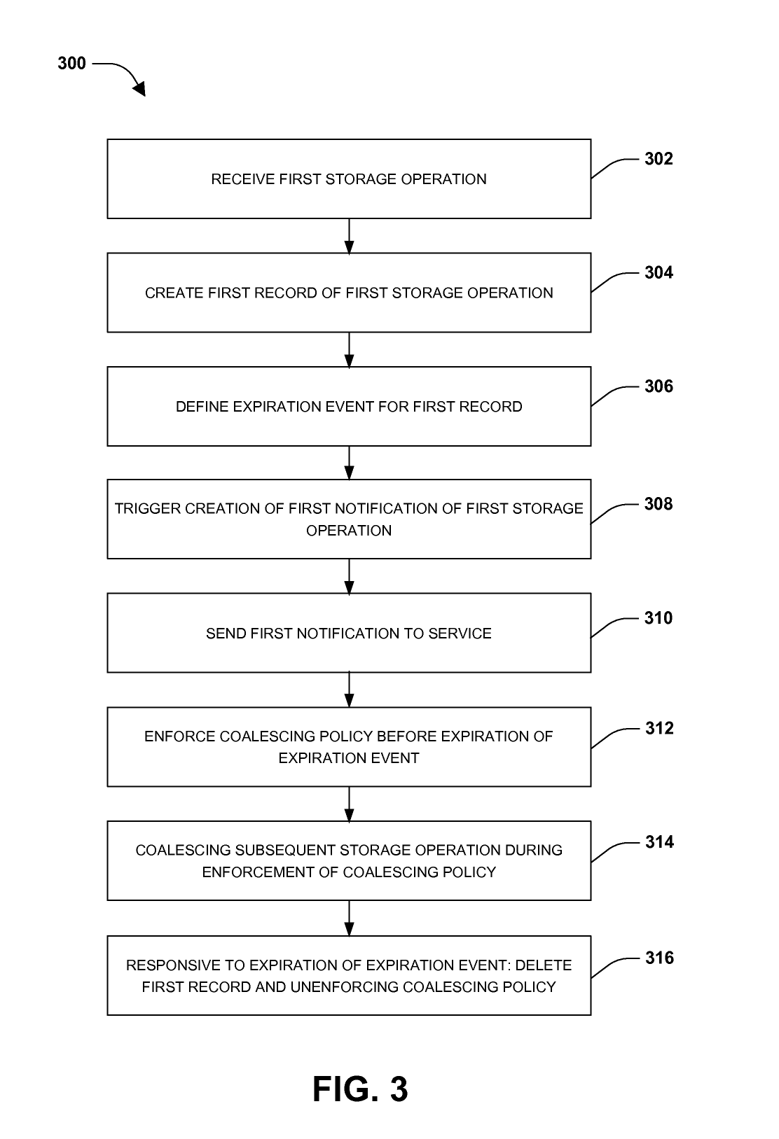

One embodiment of coalescing storage operations is illustrated by an exemplary method 300 of FIG. 3. A file server may provide clients, such as a first client, with access to files stored on one or more storage devices. In an example, the file server may be remote to a client device. A service may express an interest in receiving notifications of storage operations received by the file server from such clients. Because a plethora of storage operations may occur while a client accesses a file using a file handle (e.g., a network file system (NFS) storage operation may utilize a file handle that may be stored, cached, and/or persisted across a client reboot, and thus a significant number of storage operations, such as write operations, may occur while accessing the file using the file handle), storage operations may be coalesced, as provided herein, such that merely a single notification is created and sent to the service while a coalescing policy is being enforced.

At 302, a first storage operation may be received from a client device. The first storage operation may correspond to a storage operation type (e.g., a write operation to a text file) and a client identifier of the client device (e.g., an IP address of the client device and/or a user identifier of a user of the client device). In an example, the first storage operation comprises an NFS storage operation that utilizes a file handle to access the file, where the file handle may be stored, cached, and/or persisted across reboots of the client device. In an example, the NFS storage operation may not support file open operations and/or file close operations and/or may be associated with a protocol that does not support file open operations and/or file close operations, and thus a file access session may not be supported for the NFS storage operation (e.g., which could otherwise be used for coalescing storage operations associated with the file access session).

At 304, a first record of the storage operation may be created. For example, the file server may store the first record within a record storage data structure. The first record may comprise various information, such as the IP address, the user identifier, a file identifier of the text file, the storage operation type, a time associated with the storage operation, etc. At 306, an expiration event may be defined for the first record. In an example, an expiration time (e.g., 3 minutes) may be specified as the expiration event. In another example, a threshold number of subsequent storage operations, corresponding to the storage operation type and the client identifier (e.g., write operations from the user of the client device to the text file), may be specified as the expiration event. In another example, a receiving event, of a request for record information corresponding to the storage operation type and the client identifier, received from the service may be specified as the expiration event (e.g., the service may request record information, about the user of the client device writing to the text file, from the file server). The expiration event may be used to trigger deletion of the first record and/or unenforcement of a coalescing policy used to coalesce subsequent storage operations that are similar to the first storage operation (e.g., subsequent write operations by the user of the client device to the text file).

At 308, creation of a first notification for the first storage operation may be triggered based upon the first record. The first notification may comprise various information, such as the IP address, the user identifier, the file identifier of the text file, the storage operation type, the time associated with the storage operation, etc. At 310, the first notification may be sent to the service. In an example, the service may be hosted on a remote device that is remote to the file server and/or remote to the client device. In an example, the file server may send the first notification to a policy service that may enforce various storage policies for data accessed by clients, such as the client device. In another example, the file server may send the first notification to an auditing service that may track information related to clients accessing files. In an example, the first notification may be sent to the service before at least one subsequent storage operation is received, which may improve reliability of notification delivery to the service in the event a failure of the file server occurs before expiration of the expiration event. In another example, the first notification may be sent to the service after expiration of the expiration event, and thus a description of one or more subsequent storage operations received before expiration of the expiration event (e.g., coalesced storage operations) may be included within the first notification so that a more detailed amount of storage operation information may be provided to the service using merely a single notification (e.g., the first notification may map to multiple storage operations).

The service may be interested in whether a client device writes to the text file, but may not have an interest in each and every write operation to the text file (e.g., a plethora of write operations to the text file may occur while the user accesses, modifies, and saves the text file using the file handle). Because the subsequent write operations may be noise to the service, increase latency, and/or may consume network bandwidth and processing resources, one or more subsequent storage operations may be coalesced, as provided herein, based upon enforcement of the coalescing policy.

At 312, the coalescing policy may be enforced before expiration of the expiration event. The coalescing policy may block triggering of the creation of subsequent notifications of subsequent storage operations associated with the storage operation type and the client identifier (e.g., subsequent write operations to the text file by the user of the client device). At 314, responsive to receiving a subsequent storage operation, corresponding to the storage operation type and the client identifier, during enforcement of the coalescing policy, the subsequent storage operation may be coalesced with the first record, without triggering creation of a subsequent notification, based upon the coalescing policy. In an example of the coalescing, the first record may be updated with additional details regarding the subsequent storage operation, such that the first notification may be sent, with a description of the subsequent storage operation (e.g., and the first storage operation received at 302), to the service after expiration of the expiration event. In another example of the coalescing, the first record may remain unchanged and no additional record information may be maintained for the subsequent storage operation.

At 316, the expiration event expires (e.g., expiration of the 3 minute expiration time). Responsive to the expiration event expiring, the first record may be deleted (e.g., removed from the record storage data structure). Responsive to the expiration of the expiration event, the coalescing policy may be unenforced such that a subsequent storage operation may trigger creation of a new notification that may be sent to the service. For example, a second storage operation may be received from the client device while the coalescing policy is unenforced. The second storage operation corresponds to the storage operation type and/or the client identifier of the client device (e.g., the user of the client device may perform a second write operation to the text file). A second record of the second storage operation may be created. A second expiration event for the second record may be defined (e.g., a 3 minute expiration time). Creation of a second notification for the second storage operation may be triggered based upon the second record. The second notification may be sent to the service. The coalescing policy may be enforced before expiration of the second expiration event. For example, responsive to receiving a second subsequent storage operation, corresponding to the storage operation type and the client identifier, during enforcement of the coalescing policy, the second subsequent storage operation may be coalesced with the second record, without triggering creation of a second subsequent notification, based upon the coalescing policy. Responsive to expiration of the second expiration event, the second record may be deleted and/or the coalescing policy may be unenforced.

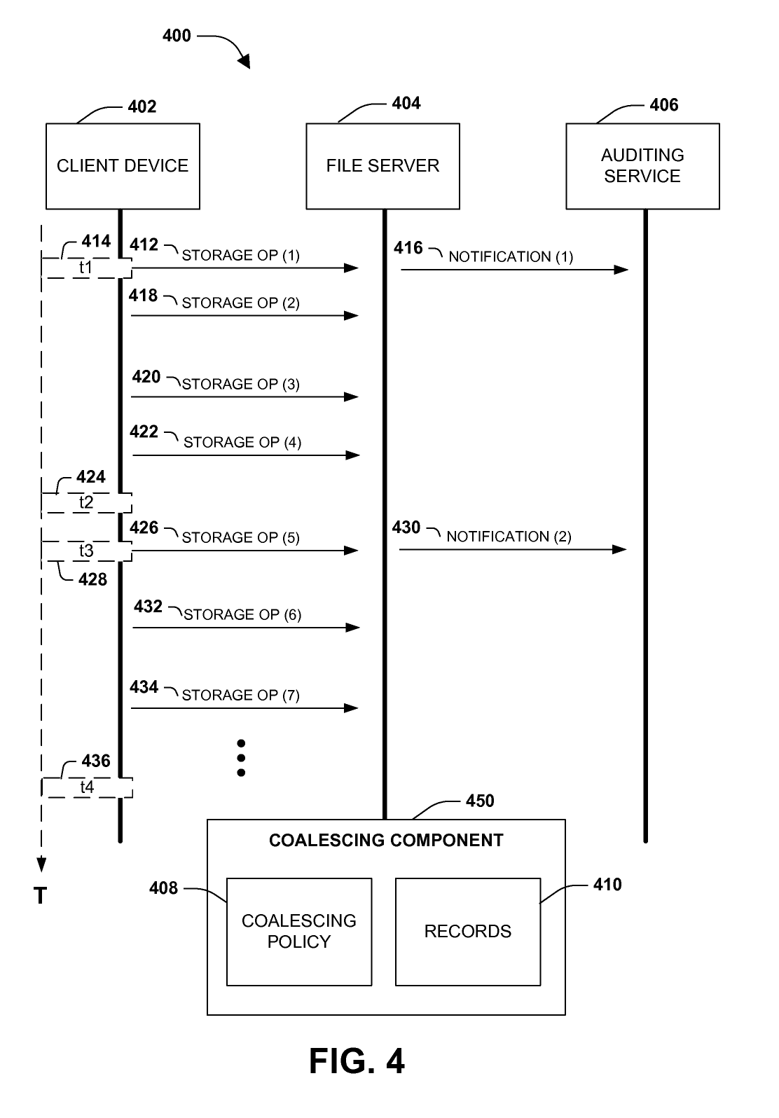

FIG. 4 illustrates an example of a system 400, comprising a coalescing component 450, for coalescing storage operations. The coalescing component 450 may be associated with a file server 404 configured to provide a client device 402 with access to data stored within one or more storage devices. An auditing service 406 may express an interest in receiving notifications of when the client device 402 and/or other client devices write to files. In an example, a first storage operation 412 may be received by the file server 404 from the client device 402 at a first time 414. The first storage operation 412 may have a storage operation type (e.g., a write operation to a file) and a client identifier of the client device 402. The coalescing component 450 may create a first record of the first storage operation 412 within a record storage data structure 410. The coalescing component 450 may create and send a first notification 416 of the first storage operation 412 to the auditing service 406 based upon the first record. An expiration event may be determined for the first record (e.g., a timespan between the first time 414 and a second time 424).

The coalescing component 450 may enforce a coalescing policy 408 before expiration of the expiration event. The coalescing policy 408 may block creation of new notifications of subsequent storage operations. For example, the coalescing component 450 may coalesce a second storage operation 418, a third storage operation 420, and a fourth storage operation 422 that are received by the file server 404 before expiration of the expiration time (e.g., before the second time 424).

Responsive to expiration of the expiration event (e.g., at the second time 424), the first record may be deleted and/or the coalescing policy 408 may be unenforced, such that a subsequent storage operation may trigger a new notification to send to the auditing service 406. For example, a fifth storage operation 426 may be received by the file server 404 from the client device 402 while the coalescing policy 408 is unenforced (e.g., at a third time 428 after the second time 424). The fifth storage operation 426 may have the storage operation type (e.g., the write operation type) and the client identifier of the client device 402. The coalescing component 450 may create a second record of the fifth storage operation 426 within the record storage data structure 410. The coalescing component 450 may create and send a second notification 430 of the fifth storage operation 426 to the auditing service 406 based upon the second record. A second expiration event may be determined for the second record (e.g., a timespan between the third time 428 and a fourth time 436). The coalescing component 450 may enforce the coalescing policy 408 before expiration of the second expiration event. The coalescing policy 408 may block creation of subsequent notifications of subsequent storage operations. For example, the coalescing component 450 may coalesce a sixth storage operation 432, a seventh storage operation 434, and/or other storage operations that are received by the file server 404 before expiration of the second expiration time (e.g., before the fourth time 436). In this way, the auditing service 406 may receive at least one notification that the client device 402 accessed the file to perform a write operation, but without being inundated with notifications of each individual write operation.

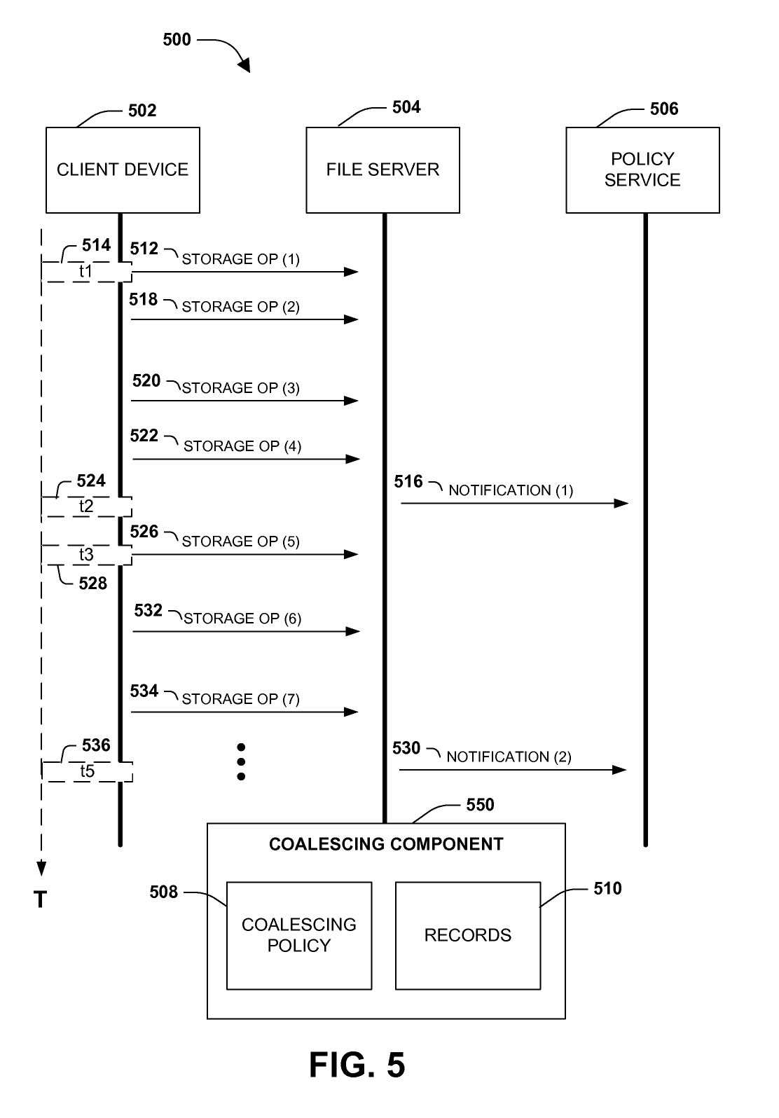

FIG. 5 illustrates an example of a system 500, comprising a coalescing component 550, for coalescing storage operations. The coalescing component 550 may be associated with a file server 504 configured to provide a client device 502 with access to data stored within one or more storage devices. A policy service 506 may express an interest in receiving notifications of when the client device 502 and/or other client devices read files. In an example, a first storage operation 512 may be received by the file server 504 from the client device 502 at a first time 514. The first storage operation 512 may have a storage operation type (e.g., a read operation to a file) and a client identifier of the client device 502. The coalescing component 550 may create a first record of the first storage operation 512 within a record storage data structure 510. An expiration event may be determined for the first record (e.g., a timespan between the first time 514 and a second time 524).

The coalescing component 550 may enforce a coalescing policy 508 before expiration of the expiration event. The coalescing policy 508 may block creation of new notifications of subsequent storage operations. For example, the coalescing component 550 may coalesce a second storage operation 518, a third storage operation 520, and a fourth storage operation 522 that are received by the file server 504 before expiration of the expiration time (e.g., before the second time 524).

Responsive to expiration of the expiration event (e.g., at the second time 524), the coalescing component 550 may create and send a first notification 516 of the first storage operation 512 to the policy service 506 based upon the first record. In an example, descriptive information, about the second storage operation 518, the third storage operation 520, and the fourth storage operation 522 that are coalesced into the first record, may be included within the first notification 516 so that the policy service 506 may receive notice of such storage operations. Responsive to expiration of the expiration event (e.g., at the second time 524), the first record may be deleted and/or the coalescing policy 508 may be unenforced, such that a subsequent storage operation may trigger creation of a second recorded used to create a new notification to send to the policy service 506. For example, a fifth storage operation 526 may be received by the file server 504 from the client device 502 while the coalescing policy 508 is unenforced (e.g., at a third time 528). The fifth storage operation 526 may have the storage operation type (e.g., a read operation type) and the client identifier of the client device 502. The coalescing component 550 may create a second record of the fifth storage operation 526 within the record storage data structure 510. A second expiration event may be determined for the second record (e.g., a timespan between the third time 528 and a fourth time 536). The coalescing component 550 may enforce the coalescing policy 508 before expiration of the second expiration event. The coalescing policy 508 may block creation of new notifications of subsequent storage operations. For example, the coalescing component 550 may coalesce a sixth storage operation 532, a seventh storage operation 534, and/or other storage operations that are received by the file server 504 before expiration of the second expiration time (e.g., before the fourth time 536). Responsive to expiration of the expiration event, the coalescing component 550 may create and send a second notification 530 of the fifth storage operation 526 to the policy service 506 based upon the second record. In an example, descriptive information about the sixth storage operation 532, the seventh storage operation 534, and/or other storage operations coalesced into the first record may be included within the second notification 516 so that the policy service 506 may receive notice of such storage operations. In this way, the policy service 506 may receive at least one notification that the client device 502 accessed the file to perform a read operation, but without being inundated with notifications of each individual read operation (e.g., a single notification may provide an indication of multiple read operations occurring).

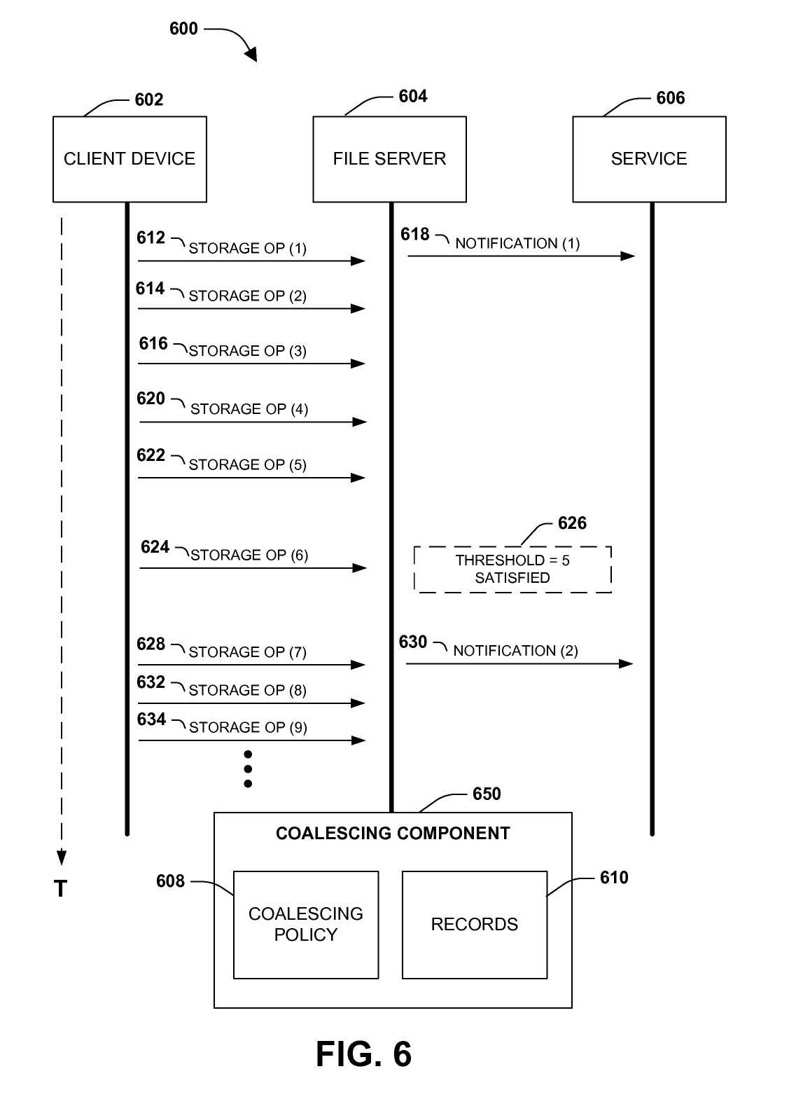

FIG. 6 illustrates an example of a system 600, comprising a coalescing component 650, for coalescing storage operations. The coalescing component 650 may be associated with a file server 604 configured to provide a client device 602 with access to data stored within one or more storage devices. A service 606 may express an interest in receiving notifications of when the client device 602 and/or other client devices write to files. In an example, a first storage operation 612 may be received by the file server 604 from the client device 602. The first storage operation 612 may have a storage operation type (e.g., a write operation type to a file) and a client identifier of the client device 602. The coalescing component 650 may create a first record of the first storage operation 612 within a record storage data structure 610. The coalescing component 650 may create and send a first notification 616 of the first storage operation 612 to the service 606 based upon the first record. An expiration event may be determined for the first record (e.g., a threshold number 626 of 5 subsequent storage operations).

The coalescing component 650 may enforce a coalescing policy 608 before expiration of the expiration event (e.g., the next 5 storage operations may be coalesced with the first record). The coalescing policy 608 may block creation of new notifications of subsequent storage operations. For example, the coalescing component 650 may coalesce a second storage operation 614, a third storage operation 616, a fourth storage operation 620, a fifth storage operation 622, and sixth storage operation 624, totaling 5 subsequent storage operations, that are received by the file server 604 before expiration of the expiration event (e.g., the expiration event may expire based upon the coalescing of the sixth storage operation 614 satisfying the threshold number 626 of 5 subsequent storage operations).

Responsive to expiration of the expiration event (e.g., the coalescing of the sixth storage operation 624 for a total of 5 coalesced subsequent storage operations 624), the first record may be deleted and/or the coalescing policy 608 may be unenforced, such that a subsequent storage operation may trigger creation of a new notification to send to the service 606. For example, a seventh storage operation 628 may be received by the file server 604 from the client device 602. The seventh storage operation 628 may have the storage operation type (e.g., the write operation type) and the client identifier of the client device 602. The coalescing component 650 may create a second record of the seventh storage operation 628 within the record storage data structure 610. The coalescing component 650 may create and send a second notification 630 of the seventh storage operation 628 to the service 606 based upon the second record. A second expiration event may be determined for the second record (e.g., a next 5 subsequent storage operations received after the creation of the second record). The coalescing component 650 may enforce the coalescing policy 608 before expiration of the second expiration event. The coalescing policy 608 may block creation of new notifications of subsequent storage operations. For example, the coalescing component 650 may coalesce an eighth storage operation 632, a ninth storage operation 634, and/or other storage operations that are received by the file server 604 before expiration of the second expiration event (e.g., before a threshold of 5 subsequent storage operations are coalesced). In this way, the service 606 may receive at least one notification that the client device 602 accessed the file to perform a write operation, but without being inundated with notifications of each individual write operation.

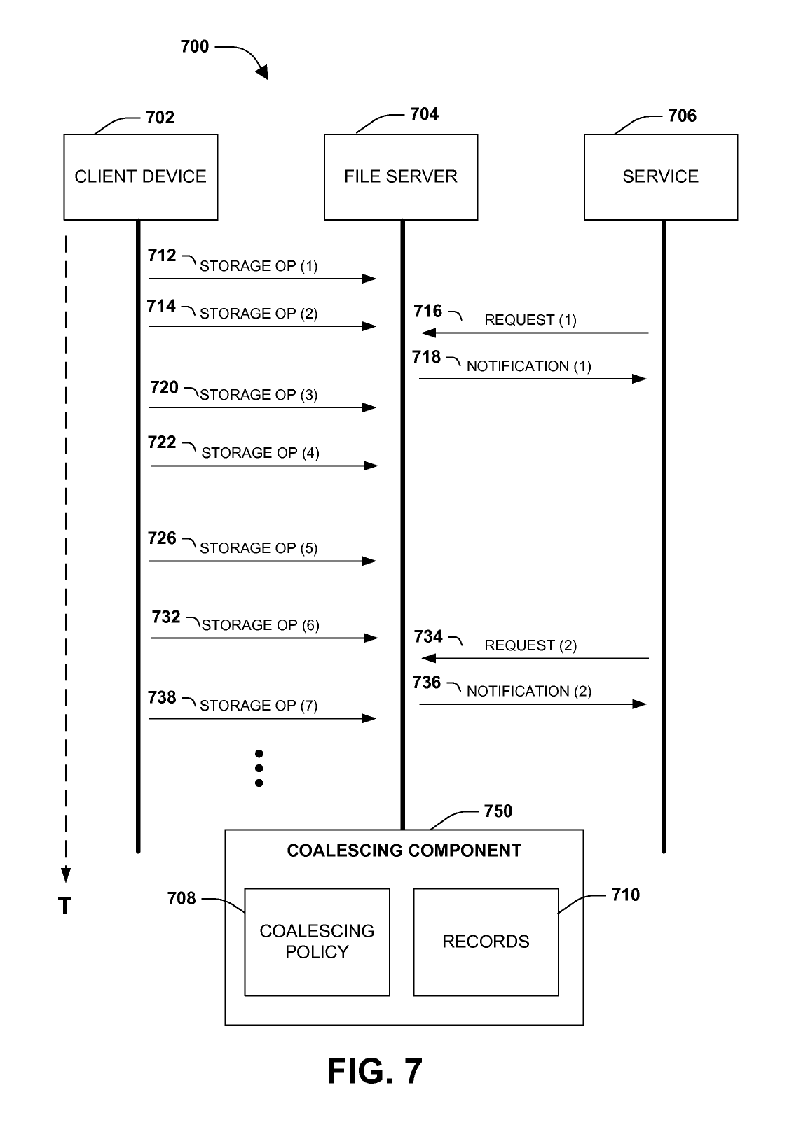

FIG. 7 illustrates an example of a system 700, comprising a coalescing component 750, for coalescing storage operations. The coalescing component 750 may be associated with a file server 704 configured to provide a client device 702 with access to data stored within one or more storage devices. A service 706 may express an interest in receiving notifications of when the client device 702 writes to files. In an example, a first storage operation 712 may be received by the file server 704 from the client device 702. The first storage operation 712 may have a storage operation type (e.g., a write operation to a file) and a client identifier of the client device 702. The coalescing component 750 may create a first record of the first storage operation 712 within a record storage data structure 710. An expiration event may be determined for the first record (e.g., subsequent storage operations may be coalesced with the first record until a receiving event of a request for record information is received from the service 706).

The coalescing component 750 may enforce a coalescing policy 708 before expiration of the expiration event (e.g., subsequent storage operations may be coalesced with the first record until a receiving event of a request for record information is received from the service 706). The coalescing policy 708 may block creation of new notifications of subsequent storage operations. For example, the coalescing component 750 may coalesce a second storage operation 714 that is received by the file server 704 before expiration of the expiration event. For example, the expiration event may expire based upon receipt of a first request 716 from the service 706, which may trigger creation of a first notification 718 to send to the service 706. The first notification may comprise information about the first record of the first storage operation 712 and/or a description of the coalesced second storage operation 714.

Responsive to expiration of the expiration event (e.g., receipt of the first request 716), the first record may be deleted and/or the coalescing policy 708 may be unenforced, such that a subsequent storage operation may trigger creation of a new record that may be used to create a new notification to send to the service 706. For example, a third storage operation 720 may be received by the file server 704 from the client device 702. The third storage operation 720 may have the storage operation type (e.g., the write operation type) and the client identifier of the client device 702. The coalescing component 750 may create a second record of the third storage operation 720 within the record storage data structure 710. A second expiration event may be determined for the second record (e.g., subsequent storage operations may be coalesced with the second record until a receiving event of a request for record information is received from the service 706). The coalescing component 750 may enforce the coalescing policy 708 before expiration of the second expiration event. The coalescing policy 708 may block creation of new notifications of subsequent storage operations. For example, the coalescing component 750 may coalesce a fourth storage operation 722, a fifth storage operation 724, and a sixth storage operation 732 that are received by the file server 704 before expiration of the second expiration time. Responsive to expiration of the second expiration event, a second notification 736 may be sent to the service 706. For example, the second expiration event may expire based upon receipt of a second request 734 from the service 706. The second notification 736 may be sent to the service 706. The second notification 736 may comprise information about the second record of the third storage operation 720 and/or a description of the coalesced storage operations (e.g., the fourth storage operation 722, the fifth storage operation 724, and the sixth storage operation 732). In this way, the service 706 may receive at least one notification that the client device 702 accessed the file to perform a write operation, but without being inundated with notifications of each individual write operation.

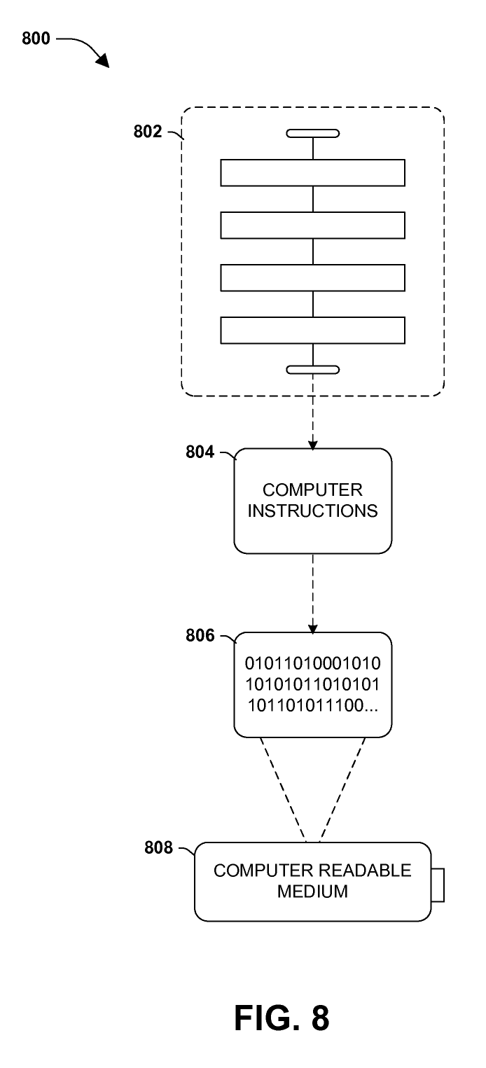

Still another embodiment involves a computer-readable medium comprising processor-executable instructions configured to implement one or more of the techniques presented herein. An example embodiment of a computer-readable medium or a computer-readable device that is devised in these ways is illustrated in FIG. 8, wherein the implementation 800 comprises a computer-readable medium 808, such as a CD-R, DVD-R, flash drive, a platter of a hard disk drive, etc., on which is encoded computer-readable data 806. This computer-readable data 806, such as binary data comprising at least one of a zero or a one, in turn comprises a set of computer instructions 804 configured to operate according to one or more of the principles set forth herein. In some embodiments, the processor-executable computer instructions 804 are configured to perform a method 802, such as at least some of the exemplary method 300 of FIG. 3, for example. In some embodiments, the processor-executable instructions 804 are configured to implement a system, such as at least some of the exemplary system 400 of FIG. 4, at least some of the exemplary system 500 of FIG. 5, at least some of the exemplary system 600 of FIG. 6, and/or at least some of the exemplary system 700 of FIG. 7, for example. Many such computer-readable media are contemplated to operate in accordance with the techniques presented herein.

It will be appreciated that processes, architectures and/or procedures described herein can be implemented in hardware, firmware and/or software. It will also be appreciated that the provisions set forth herein may apply to any type of special-purpose computer (e.g., file host, storage server and/or storage serving appliance) and/or general-purpose computer, including a standalone computer or portion thereof, embodied as or including a storage system. Moreover, the teachings herein can be configured to a variety of storage system architectures including, but not limited to, a network-attached storage environment and/or a storage area network and disk assembly directly attached to a client or host computer. Storage system should therefore be taken broadly to include such arrangements in addition to any subsystems configured to perform a storage function and associated with other equipment or systems.

In some embodiments, methods described and/or illustrated in this disclosure may be realized in whole or in part on computer-readable media. Computer readable media can include processor-executable instructions configured to implement one or more of the methods presented herein, and may include any mechanism for storing this data that can be thereafter read by a computer system. Examples of computer readable media include (hard) drives (e.g., accessible via network attached storage (NAS)), Storage Area Networks (SAN), volatile and non-volatile memory, such as read-only memory (ROM), random-access memory (RAM), EEPROM and/or flash memory, CD-ROMs, CD-Rs, CD-RWs, DVDs, cassettes, magnetic tape, magnetic disk storage, optical or non-optical data storage devices and/or any other medium which can be used to store data.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments are provided herein. The order in which some or all of the operations are described should not be construed to imply that these operations are necessarily order dependent. Alternative ordering will be appreciated given the benefit of this description. Further, it will be understood that not all operations are necessarily present in each embodiment provided herein. Also, it will be understood that not all operations are necessary in some embodiments.

Furthermore, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

As used in this application, the terms “component”, “module,” “system”, “interface”, and the like are generally intended to refer to a computer-related entity, either hardware, a combination of hardware and software, software, or software in execution. For example, a component includes a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, or variants thereof are used, such terms are intended to be inclusive in a manner similar to the term “comprising”.

Many modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first set of information and a second set of information generally correspond to set of information A and set of information B or two different or two identical sets of information or the same set of information.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for coalescing storage operations, comprising:
receiving a first storage operation from a client device, the first storage operation corresponding to a storage operation type and a client identifier of the client device;
creating a first record of the first storage operation;
defining an expiration event for the first record;
triggering creation of a first notification for the first storage operation based upon the first record;
sending the first notification to a service;
enforcing a coalescing policy before expiration of the expiration event, the coalescing policy blocking triggering of creation of subsequent notifications of subsequent storage operations associated with the storage operation type and the client identifier;
responsive to receiving a subsequent storage operation, corresponding to the storage operation type and the client identifier, during enforcement of the coalescing policy, coalescing the subsequent storage operation with the first record, without triggering creation of a subsequent notification, based upon the coalescing policy; and
responsive to expiration of the expiration event:
deleting the first record; and
unenforcing the coalescing policy.

2. The method of claim 1, the defining an expiration event comprising:
specifying an expiration time as the expiration event.

3. The method of claim 1, the defining an expiration event comprising:
specifying a threshold number of subsequent storage operations, corresponding to the storage operation type and the client identifier, as the expiration event.

4. The method of claim 1, the defining an expiration event comprising:
specifying a receiving event of a request for record information, corresponding to the storage operation type and the client identifier, from the service as the expiration event.

5. The method of claim 1, the sending the first notification comprising:
sending the first notification to the service before at least one subsequent storage operation is received.

6. The method of claim 1, the sending the first notification comprising:
responsive to expiration of the expiration event, sending the first notification to the service.

7. The method of claim 6, comprising:
including a description, of one or more subsequent storage operations received before the expiration of the expiration event, within the first notification.

8. The method of claim 1, the sending the first notification comprising:
sending the first notification from a file server, managing a file targeted by the first storage operation, to a remote device hosting the service, the remote device remote to the file server and remote to the client device.

9. The method of claim 1, the creating a first record of the first storage operation comprising:
creating, by a file server managing a file targeted by the first storage operation, the first record, the file server remote to the client device.

10. The method of claim 1, the sending the first notification comprising:
sending the first notification to an auditing service.

11. The method of claim 1, the sending the first notification comprising:
sending the first notification to a policy service.

12. The method of claim 1, the client identifier comprising at least one of an IP address of the client device or a user identifier.

13. The method of claim 1, the first storage operation comprising a network file system (NFS) storage operation.

14. The method of claim 1, comprising:
responsive to unenforcing the coalescing policy:
receiving a second storage operation from the client device, the second storage operation corresponding to the storage operation type and the client identifier of the client device;
creating a second record of the second storage operation;
defining a second expiration event for the second record;
triggering creation of a second notification for the second storage operation based upon the second record;
sending the second notification to the service; and
enforcing the coalescing policy before expiration of the second expiration event.

15. The method of claim 14, comprising:
responsive to receiving a second subsequent storage operation, corresponding to the storage operation type and the client identifier, during enforcement of the coalescing policy, coalescing the second subsequent storage operation with the second record, without triggering creation of a second subsequent notification, based upon the coalescing policy; and
responsive to expiration of the second expiration event:
deleting the second record; and
unenforcing the coalescing policy.

16. A system for coalescing storage operations, comprising:
a coalescing component configured to:
receive a first storage operation from a client device, the first storage operation corresponding to a storage operation type and a client identifier of the client device;
create a first record of the first storage operation;
define an expiration event for the first record;
trigger creation of a first notification for the first storage operation based upon the first record;
send the first notification to a service;
enforce a coalescing policy before expiration of the expiration event, the coalescing policy blocking triggering of creation of subsequent notifications of subsequent storage operations associated with the storage operation type and the client identifier;
responsive to receiving a subsequent storage operation, corresponding to the storage operation type and the client identifier, during enforcement of the coalescing policy, coalesce the subsequent storage operation with the first record, without triggering creation of a subsequent notification, based upon the coalescing policy; and
responsive to expiration of the expiration event:
deleting the first record; and
unenforce the coalescing policy.

17. The system of claim 16, the first storage operation comprising a network file system (NFS) storage operation.

18. The system of claim 16, the coalescing component configured to:
send the first notification from a file server, managing a file targeted by the first storage operation, to a remote device hosting the service, the remote device remote to the file server and remote to the client device.

19. The system of claim 16, the coalescing component configured to:
define the expiration event based upon at least one of an expiration time, a threshold number of subsequent storage operations, or a receiving event for record information from the service.

20. A computer readable medium comprising instructions which when executed perform a method for coalescing storage operations, comprising:
receiving a first storage operation from a client device, the first storage operation corresponding to a storage operation type and a client identifier of the client device;
creating a first record of the first storage operation;
defining an expiration event for the first record;
triggering creation of a first notification for the first storage operation based upon the first record;
sending the first notification to a service;
enforcing a coalescing policy before expiration of the expiration event, the coalescing policy blocking triggering of creation of subsequent notifications of subsequent storage operations associated with the storage operation type and the client identifier;
responsive to receiving a subsequent storage operation, corresponding to the storage operation type and the client identifier, during enforcement of the coalescing policy, coalescing the subsequent storage operation with the first record, without triggering creation of a subsequent notification, based upon the coalescing policy; and
responsive to expiration of the expiration event:
deleting removing the first record; and
unenforcing the coalescing policy.
